(19) United States
(12) Patent Application Publication
(10) Pub. No.: US 2026/0128779 A1
(43) Pub. Date: May 7, 2026

(54) SYSTEMS AND METHODS FOR IMPROVED GROUP-BASED BEAM REPORTING

(71) Applicant: APPLE INC., Cupertino, CA (US)

(72) Inventors: Xiang Chen, Campbell, CA (US); Haitong Sun, Cupertino, CA (US); Jie Cui, San Jose, CA (US); Manasa Raghavan, Sunnyvale, CA (US); Yang Tang, San Jose, CA (US); Qiming Li, Beijing (CN); Yuexia Song, Beijing (CN); Dawei Zhang, Saratoga, CA (US); Rolando E Bettancourt Ortega, Munich (DE)

(21) Appl. No.: 19/119,970

(22) PCT Filed: Nov. 2, 2022
(86) PCT No.: PCT/CN2022/129324

§ 371 Date: Apr. 10, 2025

(51) Int. Cl. H04B 7/06; H04B 17/309; H04B 17/318

(52) U.S. Cl. CPC H04B 7/06952; H04B 17/328; H04B 17/346

(57) ABSTRACT

Systems and methods for group-based beam reporting are disclosed herein. A user equipment (UE) may determine first and second characteristics of first and second beams used by the network and that are received at the UE in a simultaneous fashion. The UE is configured to identify the first and second beams as a qualified beam pair upon analyzing a characteristic of first beam and a characteristic of second beam in relation to a threshold, and then send the network a beam reporting message identifying the first beam and the second beam as a qualified beam pair. The network may then use this beam pair to communicate with the UE. Relevant beam characteristics, threshold types, and related analyses are discussed. Uses of beam pair validity timers during which a reported qualified beam pair is valid are discussed. Updates to a qualified beam pair are discussed.

### TECHNICAL FIELD

This application relates generally to wireless communication systems, including wireless communications system using group-based beam reporting.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and Institute of Electrical and Electronics Engineers (IEEE) 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

Frequency bands for 5G NR may be separated into two or more different frequency ranges. For example, Frequency Range 1 (FR1) may include frequency bands operating in sub 6 gigahertz (GHz) frequencies, some of which are bands that may be used by previous standards, and may potentially be extended to cover new spectrum offerings from 410 megahertz (MHz) to 7125 MHz. Frequency Range 2(FR2) may include frequency bands from 24.25 GHz to 52.6 GHz. Note that in some systems, FR2 may also include frequency bands from 52.6 GHz to 71 GHz (or beyond). Bands in the millimeter wave (mmWave) range of FR2 may have smaller coverage but potentially higher available bandwidth than bands in FR1. Skilled persons will recognize these frequency ranges, which are provided by way of example, may change from time to time or from region to region.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a diagram showing a UE according to embodiments herein.

FIG. 2 illustrates a diagram showing a first CMR set and a first CMR set, according to embodiments herein.

FIG. 3 illustrates a method of a UE, according to embodiments herein.

FIG. 4 illustrates a method of a RAN, according to embodiments herein.

FIG. 5 illustrates a method of a RAN, according to embodiments herein.

FIG. 6 illustrates a method of a RAN, according to embodiments herein.

FIG. 7 illustrates an example architecture of a wireless communication system, according to embodiments disclosed herein.

FIG. 8 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

In some cases, multiple receive (multi-Rx) chain downlink (DL) reception at a UE may be beneficial. In some cases, such multi-Rx chain DL reception mechanisms may be used in FR2. In such cases, it may be beneficial to introduce mechanisms for simultaneous DL reception from different directions with different quasi-colocation (QCL) TypeD reference signals (RSs) on a single component carrier (e.g., that may be used with enhanced FR2-1 UEs or other UEs).

In some instances, it may be beneficial to specify one or more of: a layer 1 (L1) reference signal received power (RSRP) (L1-RSRP) measurement delay; a layer 3(L3) measurement delay (e.g., cell detection delay and/or measurement period), where a starting point may be enhancement related to L1-RSRP measurement enhancements; radio link monitoring (RLM), bidirectional forward detection (BFD), and/or candidate beam detection (CBD) requirements; scheduling and/or measurement restrictions; transmission configuration indicator (TCI) state switching delay with dual TCI; and/or receive (Rx) timing difference between different directions (e.g., different QCL Type D RSs).

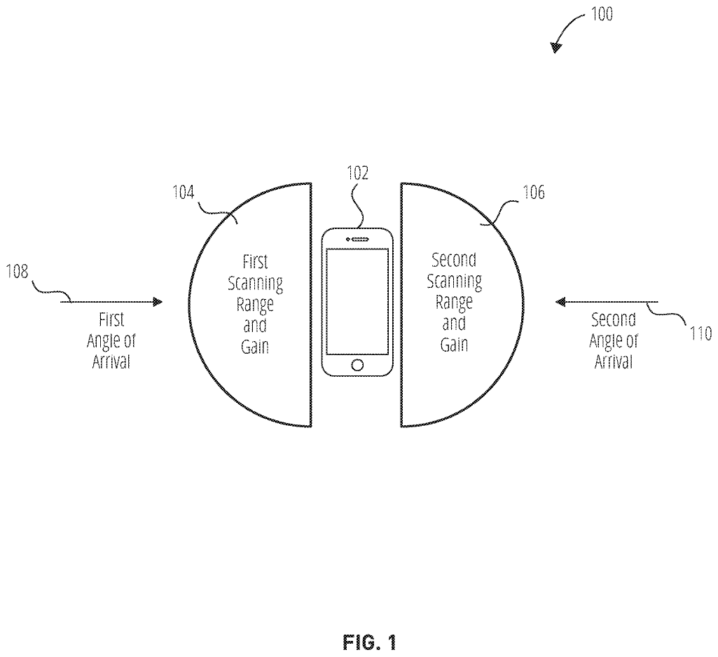

FIG. 1 illustrates a diagram 100 showing a UE 102 according to embodiments herein. The UE 102 may be capable of simultaneously receiving two beams used by the network using two antenna panels of the UE (with one antenna panel used for the receipt of a corresponding one of the two beams from the network). The diagram 100 accordingly illustrates a first scanning range and gain 104 of a first antenna panel of the UE 102 and a second scanning range and gain 106 of a second antenna panel of the UE 102 (which may be, for example, different than the first scanning range and gain 104) corresponding to this function. Under such circumstances, it may be understood that the first beam may arrive at the first antenna panel at a first angle of arrival 108 while the second beam may arrive at the second antenna panel at a second angle of arrival 110, as illustrated. Note that it is contemplated that, in some embodiments, this arrangement may be used to successfully receive multiple beams used by the network on the same component carrier (CC), while in other embodiments, the multiple beams may be of different CCs (e.g., carrier aggregation (CA) may be used).

In some cases, a first antenna panel and a second antenna panel are separate physical panels of the UE. However, it is noted that antenna panel as used herein may also be understood to refer to a logical antenna panel concept. Accordingly, it will be understood that the cases described herein of, e.g., first and second antenna panels, also encompasses cases where a single physical antenna panel module is used, where the first panel corresponds to a first weighting on that antenna panel module while the second panel corresponds to a second weighting on that antenna panel module.

Beam reporting mechanisms may allow for the UE to report, to a network, a pair of beams which the UE has the capability of using according to multiple receive (multi-Rx) chain downlink (DL) reception functionality.

Two example beam reporting mechanisms that may be used in wireless communications systems which allow a UE to support simultaneous reception of multiple beams (e.g., on the same CC or on different CCs) from different directions corresponding to different QCL TypeD RSs are described. A first such mechanism may use group-based beam reporting, and it may be that a UE can report one pair of beams that it is capable of receiving simultaneously. In a second such mechanism, it may be that group-based beam reporting is used, and a UE may be able to report up to four pairs of beams.

It may be that in whatever case, for each of (one or more) beam pairs reported by the UE in a beam reporting message to the network, the UE may report L1-RSRP values for each beam in the pair. For example, if a beam pair including beams B1 and B2 is to be reported by the UE in a beam reporting message, the UE also reports the associated L1-RSRP for each of B1 and B2.

Herein, the L1-RSRP for each of, for example, B1 and B2 may be referred to respectively as RSRP_B1, RSRP_B2 according to convention used in this disclosure. Similar conventions may be followed herein with regard to other characteristics of a beam. For example, an L1-SINR for each of B1 and B2 may be referred to respectively as SINR_B1, SINR_B2 according to convention used in this disclosure. As a further example, an angle of arrival (AoA) for each of B1 and B2 may be referred to respectively as AoA B1 and AoA B2.

In order to improve performance, the following aspects may be considered. Firstly, it has been identified that it is useful to define the use of one or more UE reporting criteria for beam pair reporting. That is, criteria for determining, at the UE, whether or not a beam pair has attributes such that it is desirable for use by the network for simultaneous DL communications to the UE (e.g., on the same CC or on different CCs), such that the UE elects to report the beam pair to the network may be established. A beam pair that is determined by the UE to have attributes according to such criteria making it desirable for, e.g., simultaneous DL communications to the UE may be referred to herein as a “qualified beam pair.”

Secondly, it has been identified that it is useful to establish a particular manner of updating a reported pair of beams. For example, in existing wireless communications systems, there may be no mechanism for determining whether a previously reported beam pair remains valid/useful at the UE, and/or how such information should be updated from/by the UE to the network as related circumstances change.

### Embodiments of Beam Pair Reporting Criteria

Embodiments related to the use of beam pair reporting criteria are now discussed. Such embodiments may relate to, for example, determinations at the UE regarding whether a first beam and a second beam receivable at the UE together constitute a qualified beam pair that should be reported to the network for (potential) use by the network for simultaneous communication with the UE. Herein, a first beam for such a consideration may be referred to as B1 and a second beam for such a consideration may be referred to as B2.

Consistent with description herein, one or more characteristics of each of B1 and B2 may be applied with one or more conditions in order to determine whether B1 and B2 represent a qualified beam pair. Examples of such characteristics that may be so used include, but are not limited to, RSRP (e.g., L1-RSRP) values for each of B1 and/or B2, AoA at the UE of each of B1 and/or B2, a signal to noise and interference ratio (SINR) of each of B1 and/or B2, etc.

In some cases of the use of such conditions, it may be that RSRP_B1 and RSRP_B2 are applied in relation to a relevant threshold value.

For example, a first condition may use an RSRP threshold value applicable to each of RSRP_B1 and RSRP_B2. The first condition may require that each of RSRP_B1 and RSRP_B2 is greater than or equal to (or greater than) the RSRP threshold value in order for B1 and B2 to be identified as a qualified beam pair. Accordingly, the UE may compare each of RSRP_B1 and RSRP_B2 to the RSRP threshold value and identify B1 and B2 as a qualified beam pair if each is greater than or equal to (or greater than) the RSRP threshold value.

As another example, a second condition may use an RSRP difference threshold value. The second condition may require that a difference between RSRP_B1 and RSRP_B2 is greater than or equal to (or greater than) the RSRP difference threshold value in order for B1 and B2 to be identified as a qualified beam pair. Accordingly, the UE may calculate a difference between RSRP_B1 and RSRP_B2, compare the difference to the RSRP difference threshold value, and identify B1 and B2 as a qualified beam pair if this difference is greater than or equal to (or greater than) the RSRP difference threshold value.

In some cases of the use of such conditions, it may be that AoA_B1 and an AoA_B2 are applied in relation to a relevant threshold value.

For example, a third condition may use an AoA offset threshold value. The third condition may require that an offset (e.g., an angular difference) between AoA_B1 and AoA_B2 is greater than or equal to (or greater than) the AoA offset threshold value in order for B1 and B2 to be identified as a qualified beam pair. Accordingly, the UE may calculate an offset between AoA_B1 and AoA_B2, compare this offset to the AoA offset threshold value, and identify B1 and B2 as a qualified beam pair if this offset is greater than or equal to (or greater than) the AoA offset threshold value.

In some cases of the use of such conditions, it may be that SINR_B1 and SINR_B2 are applied in relation to a relevant threshold value.

For example, a fourth condition may use an SINR threshold value applicable to each of SINR_B1 and SINR_B2. The fourth condition may require that each of SINR_B1 and SINR_B2 is greater than or equal to (or greater than) the SINR threshold value in order for B1 and B2 to be identified as a qualified beam pair. Accordingly, the UE may compare each of SINR_B1 and SINR_B2 to the SINR threshold value and identify B1 and B2 as a qualified beam pair if each is greater than or equal to (or greater than) the SINR threshold value.

As another example, a fifth condition may use an SINR difference threshold value. The fifth condition may require that a difference between SINR_B1 and SINR_B2 is greater than or equal to (or greater than) the SINR difference threshold value in order for B1 and B2 to be identified as a qualified beam pair. Accordingly, the UE may calculate a difference between SINR_B1 and SINR_B2, compare the difference to the SINR difference threshold value, and identify B1 and B2 as a qualified beam pair if this difference is greater than or equal to (or greater than) the SINR difference threshold value.

It is noted that the particular examples of conditions discussed herein are given by way of example and not by way of limitation.

Further, it is contemplated that in some embodiments, multiple conditions may be used when evaluating whether a pair of beams B1 and B2 are a qualified beam pair. For example, two (or more) of the conditions described herein may need to be satisfied in the manner described prior to the UE identifying that B1 and B2 are a qualified beam pair.

Note also that it has been recognized that in some cases, a beam reporting message identifying a qualified beam pair B and B2 may include more than, e.g., RSRP_B1 and RSRP_B2. For example, it may be in some cases that an SINR_B1 and SINR_B2 are (e.g., also) reported in the beam reporting message that identifies B1 and B2 as a qualified pair. Note that the use of the SINR values in the beam reporting message in this manner may correspond to the use of one or more SINR-related conditions by the UE to identify B1 and B2 as a qualified beam pair, as described herein.

The potential sources for relevant threshold values corresponding to the conditions used is now discussed. In some cases, the threshold value used may be a single pre-defined value at the UE for the corresponding condition.

In other cases, the threshold value used may be one of a pre-defined range of values for the corresponding condition at the UE. In some such cases, the one of the pre-defined values for the condition that is used at the UE may be signaled by the network to the UE when group-based beam reporting is configured to a UE. In other such cases, the one of the pre-defined values for the condition that is used at the UE may be signaled by the UE to the network in a UE capability message as corresponding to a UE capability.

It is possible, in cases where more than two beams are tested by the UE, that the UE may identify multiple qualified beam pairs through the use of one or more conditions as described herein. In cases where there are multiple qualified beam pairs identified, the UE may report them together in a single beam reporting message. Prior to sending such a beam reporting message, it may be that the UE ranks the qualified beam pairs within the beam reporting message.

Mechanisms for ranking multiple qualified beam pairs are now discussed. In some cases, the UE may rank a set of qualified pairs each having beams B1 and B2 based on sum of their respective RSRP_B1 and RSRP B2 values. In such a case, it may be that the qualified beam pair with the largest sum ranks first, the qualified beam pair with the second largest sum ranks second, and so forth. Note that a summation for these RSRP values can be perform in either the linear domain or the logarithmic domain.

In some cases, the UE may rank a set of qualified beam pairs each having beams B1 and B2 based on a minimum value between RSRP_B1 and RSRP_B2 for each beam pair (which may be denoted min(RSRP_B1, RSRP_B2) for the beam pair). In such a case, it may be that the qualified beam pair with the largest min(RSRP_B1, RSRP_B2) ranks first, the qualified beam pair with the second largest min(RSRP_B1, RSRP_B2) ranks second, and so forth.

In some cases, the UE may rank a set of qualified beam pairs each having beams B1 and B2 based on a maximum value between RSRP_B1 and RSRP_B2 for each beam pair (which may be denoted max(RSRP_B1, RSRP_B2) for the beam pair). In such a case, it may be that the qualified beam pair with the largest max(RSRP_B1, RSRP_B2) ranks first, the qualified beam pair with the second largest max(RSRP_B1, RSRP_B2) ranks second, and so forth.

In some cases, the UE may rank a set of qualified pairs each having beams B1 and B2 based on sum of their respective SINR_B1 and SINR_B2 values. In such a case, it may be that the qualified beam pair with the largest sum ranks first, the qualified beam pair with the second largest sum ranks second, and so forth.

In some cases, the UE may rank a set of qualified pairs each having beams B1 and B2 based on the sum of their corresponding effective channel capabilities, where the effective channel capability corresponding to each of B1 and B2 is calculated using SINR B1 and SINR_B2 respectively. For example, the effective channel capability for B1 may be calculated as log(1+SINR_B1) and the effective channel capability for B2 may be calculated as log(1+SINR_B2). Once the sum of these two values is calculated for each qualified beam pair, the qualified beam pair with the largest such sum ranks first, the qualified beam pair with the second largest such sum ranks second, and so forth.

In some cases, the UE may rank a set of qualified beam pairs each having beams B1 and B2 based on a minimum value between SINR_B1 and SINR_B2 for each beam pair (which may be denoted min(SINR_B1, SINR_B2) for the beam pair). In such a case, it may be that the qualified beam pair with the largest min(SINR_B1, SINR_B2) ranks first, the qualified beam pair with the second largest min(SINR_B1, SINR_B2) ranks second, and so forth. Note that the largest min(SINR_B1, SINR_B2) may relate to the minimum data rate supported at each beam, so the ranking on this basis may assist the network in making quality of service (QoS)-related determinations.

In some cases, the UE may rank a set of qualified beam pairs each having beams B1 and B2 based on a maximum value between SINR_B1 and SINR_B2 for each beam pair (which may be denoted max(SINR_B1, SINR_B2) for the beam pair). In such a case, it may be that the qualified beam pair with the largest max(SINR_B1, SINR_B2) ranks first, the qualified beam pair with the second largest max(SINR_B1, SINR_B2) ranks second, and so forth.

It is noted that the particular examples of ranking mechanisms discussed herein are given by way of example and not by way of limitation.

It is contemplated that multiple ranking mechanisms could be applied by the UE corresponding to a multiple-order ranking. For example, it may be that a first order ranking uses a first ranking mechanism, and that a second order ranking (e.g., to break any ties occurring based on the first order ranking) may use a different ranking mechanism, etc.

In some embodiments, it may be that the network (e.g., a base station) can further configure/restrict the beam pairs that can be reported by the UE. This may be useful in cases where it is desired to incorporate the effects of an AoA and/or an angle of departure (AoD) corresponding to the beams into the analysis, and where it cannot be assumed that the UE is capable of independently generating this information based on its receipt of the beams (e.g., because the UE is only capable of using relatively wide Rx beams on its antenna panels).

In some wireless communications systems, group-based beam reporting may include the use of channel measurement resource (CMR) sets that are known to the UE (e.g., via network configuration). It may be that the beams to be measured by the UE are each identified in one of two such CMR sets.

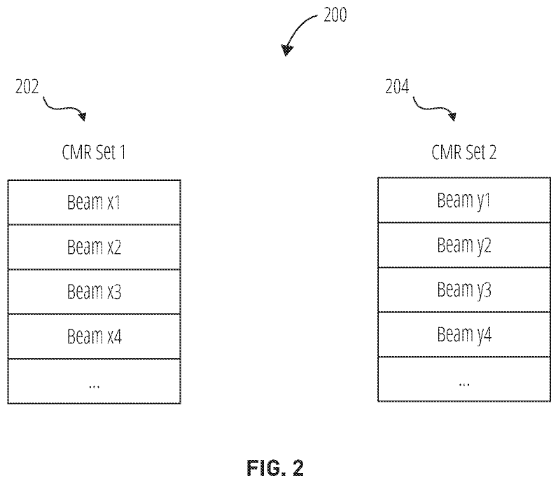

FIG. 2 illustrates a diagram 200 showing a first CMR set 202 and a second CMR set 204, according to embodiments herein. The first CMR set 202 and the second CMR set 204 may have been configured to a UE by a network. As may be seen, the first CMR set 202 identifies a first set of beams (beam x1, beam x2, . . . ) while the second CMR set 204 identifies a second set of beams (beam y1, beam y2, . . . ).

It may be that when checking for qualified sets of beams, the UE restricts the determination of and/or reporting of qualified beam pairs to beam pairs where one beam is from the first of two CMR sets (e.g., the first CMR set 202) and one beam is from the second of the two CMR sets (e.g., the second CMR set 204). Herein, such a beam pair may be referred to as a beam pair that is taken across the two CMRs.

Note that, consistent with discussion herein relating UE that do not themselves independently determine AoA/AoD characteristics of beams, it may be in some embodiments that the network has configured the first CMR set 202 with first beams having first AoA/AoD characteristics and the second CMR set 204 with second beams having second AoA/AoD characteristics.

In some embodiments, the UE is free to analyze beam pairs taken across two CMR sets in the described manner with full flexibility (e.g., no restrictions other than that beam pairs are to be taken across the two CMR sets).

However, it is contemplated that in some embodiments, the network (e.g., a base station) may further configure the UE with a list of pairs that is a subset of all possible beam pairs taken across the first CMR and the second CMR in the described manner. This list of pairs may represent beam pairs taken across the first CMR and the second CMR that the UE may report as qualified beam pairs (with no other such beam pairs taken across the first CMR and the second CMR being allowed/eligible). Alternatively, this list of pairs may represent beam pairs taken across the first CMR and the second CMR that the UE may not report as qualified beam pairs (with all other such beam pairs taken across the first CMR and the second CMR being allowed/eligible).

It is contemplated that in some wireless communications systems (e.g., not necessarily using CMRs as has been described), the network (e.g., a base station) may configure the UE with a list of beam pairs representing beam pairs that are (or that are not) allowed/eligible for identification as a qualified beam pair. The configuration of this list may, in some cases, account for any lack of ability by the UE to independently determine AoA/AD characteristics of beams, as has been described.

Further potential restrictions for the analysis of a candidate beam pair are now described. In some embodiments for analyzing a pair of beams B1 and B2, it may be that the measurement of different reference signal types on each of the beams (e.g., a measurement on a channel state information reference signal (CSI-RS) on B1 and a measurement of a synchronization signal block (SSB) on B2) is permitted in order to analyze B1 and B2 for qualification purposes. However, in other embodiments, the network may instruct the UE to (or the UE may be pre-configured to) use measurements of only a single (same) reference signal type on each of B1 and B2 to determine whether B1 and B2 are a qualified beam pair. Resulting examples in such cases may be that the UE measures CSI-RSs on each of B1 and B2, the UE measures SSBs on each of B1 and B2, etc.

In some embodiments, it may be that the use of different reference signal types across different determinations for different candidate beam pairs is permitted (e.g., a first candidate beam pair may be analyzed based on one or more CSI-RSs, while a second candidate beam pair may be analyzed based on one or more SSBs). However, in other embodiments, the network may instruct the UE to (or the UE may be configured to) use only the same (e.g., single) reference signal type across its analyses of various candidate beam pairs. A resulting example in such cases may be that the analysis of multiple beam pairs uses, e.g., CSI-RSs on each of the beams.

Various options for network-side considerations regarding the validity of a beam pair are now discussed.

In a first option, for a qualified beam pair reported by the UE, the network starts a beam pair validity timer corresponding to that qualified beam pair. When the timer expires, the network considers the beam pair no longer valid/usable. In some embodiments, the staring value for the beam pair validity timer is provided to the network by the UE in a beam reporting message that indicates the qualified beam pair.

The starting value for the beam pair validity timer may be pre-defined (e.g., per a specification for the wireless communication system). The pre-definition may be of a single starting value. Alternatively, the pre-definition may be of a range of such starting values.

In some cases, it may be that the network configures two active transmission configuration indicator (TCI) states to the UE, one corresponding to each beam of the reported beam pair. In such circumstances, it may be that if the network receives a hybrid automatic repeat request acknowledgement (HARQ-ACK) from the UE corresponding to each of the first TCI state and the second TCI state, the beam pair validity timer for that beam pair is reset.

In some embodiments, once the beam pair validity timer expires, the network may initiate another group-based beam reporting procedure with the UE (e.g., in order to establish a new qualified beam pair to use for communications with the UE).

In some embodiments, the UE may transmit an override message to the network to override a beam pair validity timer, if the UE determines the beam pair is (e.g., still) valid. The override message can be sent to the network via any of radio resource control (RRC) message, a medium access control control element (MAC-CE), and/or an uplink control information (UCI) in various embodiments. In response to the override message, the network may reset the beam pair validity timer (e.g., to the original value and/or to a value that is specified by the UE in the override message).

Second options for network-side considerations regarding the validity of a beam pair at the network may be as follows. When periodic/semi-periodic group based reporting is in use, it may be that correspondingly periodic/semi-periodic beam reporting messages are received from the UE at the network. In such cases, the network may understand that the most recently reported beam pair(s) overrides previously reported beam pair(s). Further, if a beam pair validity timer (e.g., as described herein) is also used in such cases, it may be reset upon receiving each periodic/semi-periodic beam reporting message.

In some cases, it may be that a UE initiates a beam pair update by sending the network a beam pair update message. The beam pair update message may indicate, for example, one or two replacement beams for one or two of the beams B1, B2 that constitute a current qualified beam pair as understood at the network. Upon receiving the beam pair update message, the network may replace the beams B1 and/or B2 with the corresponding replacement beam(s) from the beam pair update message.

In some such cases, the beam pair update message can be considered/transmitted by the UE as UCI. In a first such alternative, the beam pair update message may be treated as special channel state information (CSI) feedback from the UE to the network. Under this alternative, it may be that the beam pair update message has a same priority as existing CSI in use, for example, a same priority as for L1-RSRP CSI feedback or for L1-SINR CSI feedback.

In a second such alternative of a beam pair update message as UCI, the beam pair update message may be treated/transmitted as a new type of UCI (e.g., in addition to the existing UCI like scheduling request (SR)/HARQ-ACK/CSI/configured grant uplink control information (CG-UCI), etc., which may be used in the wireless communication system). Under this alternative, the beam pair update message may be encoded standalone, using polar code. Alternatively, the beam pair update message may be jointly encoded with other types of UCI using polar code.

In other case for beam pair update messages (e.g., other than a beam pair update message as UCI as just discussed), a beam pair update message may be transmitted in a MAC-CE. In such cases, if the UE already has an uplink (UL) grant for physical uplink control channel (PUSCH) transmission, UE can transmit the MAC-CE using the existing UL grant. Alternatively, if the UE does not already have UL grant for PUSCH, one or both of the following two options may be considered.

In the first option, the UE may request a UL grant via an SR. It may be that the network previously configured the UE with a specific SR resource for the dedicated use by the UE for providing a beam pair update message in such an SR. This SR may have a same or a different priority compared to any other types of SRs in use during UCI multiplexing and collision handling.

Alternatively, the network and the UE use an existing SR (e.g., that is nominally for other purposes, at least in part).

In the second option, the UE may request a UL grant via random access channel (RACH) procedure. Depending on implementation, it may be that one or both of a contention free random access (CFRA) RACH procedure and/or a contention based random access (CBRA) RACH procedure is used for this purpose.

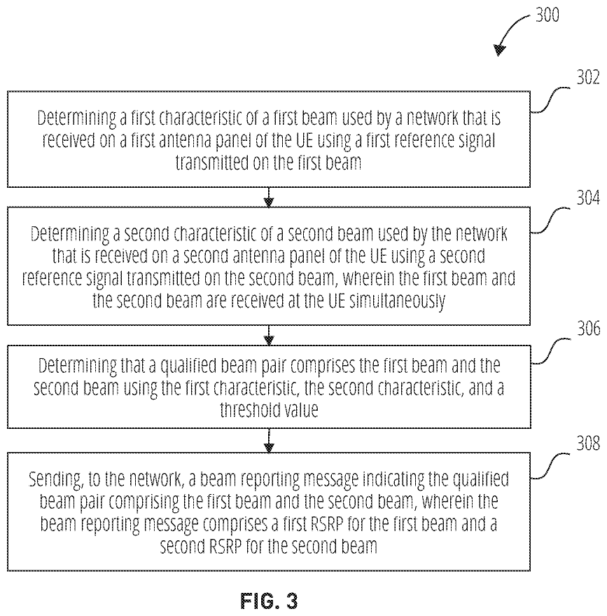

FIG. 3 illustrates a method 300 of a UE, according to embodiments herein. The method 300 includes determining 302 a first characteristic of a first beam used by a network that is received on a first antenna panel of the UE using a first reference signal transmitted on the first beam.

The method 300 further includes determining 304 a second characteristic of a second beam used by the network and that is received on a second antenna panel of the UE using a second reference signal transmitted on the second beam, wherein the first beam and the second beam are received at the UE simultaneously.

The method 300 further includes determining 306 that a qualified beam pair comprises the first beam and the second beam using the first characteristic, the second characteristic, and a threshold value.

The method 300 further includes sending 308, to the network, a beam reporting message indicating the qualified beam pair comprising the first beam and the second beam, wherein the beam reporting message comprises a first RSRP for the first beam and a second RSRP for the second beam.

In some embodiments of the method 300, the first characteristic of the first beam comprises the first RSRP for the first beam, the second characteristic comprises the second RSRP for the second beam, the threshold value comprises an RSRP threshold value, and the determining that the qualified beam pair comprises the first beam and the second beam comprises comparing the first RSRP to the RSRP threshold value and comparing the second RSRP to the RSRP threshold value.

In some embodiments of the method 300, the first characteristic of the first beam comprises the first RSRP for the first beam, the second characteristic comprises the second RSRP for the second beam, the threshold value comprises an RSRP difference threshold value, and the determining that the qualified beam pair comprises the first beam and the second beam comprises calculating a difference between the first RSRP and the second RSRP and comparing the difference between the first RSRP and the second RSRP to the RSRP difference threshold value.

In some embodiments of the method 300, the first characteristic of the first beam comprises a first AoA for the first beam, the second characteristic comprises a second AoA for the second beam, the threshold value comprises an AoA offset threshold value, and the determining that the qualified beam pair comprises the first beam and the second beam comprises calculating an offset between the first AoA and the second AoA and comparing the offset between the first AoA and the second AoA to the AoA offset threshold value.

In some embodiments of the method 300, the first characteristic of the first beam comprises a first SINR for the first beam, the second characteristic comprises a second SINR for the second beam, the threshold value comprises an SINR threshold value, and the determining that the qualified beam pair comprises the first beam and the second beam comprises comparing the first SINR to the SINR threshold value and comparing the second SINR to the SINR threshold value.

In some embodiments of the method 300, the first characteristic of the first beam comprises a first SINR for the first beam, the second characteristic comprises a second SINR for the second beam, the threshold value comprises an SINR difference threshold value, and the determining the qualified beam pair comprises the first beam and the second beam comprises calculating a difference between the first SINR and the second SINR and comparing the difference between the first SINR and the second SINR to the SINR difference threshold value.

In some embodiments of the method 300, the first characteristic of the first beam comprises the first RSRP for the first beam, the second characteristic comprises the second RSRP for the second beam, the threshold value comprises one of an RSRP threshold value and an RSRP difference threshold value, and the determining that a qualified beam pair comprises the first beam and the second beam further comprises using a first SINR for the first beam, a second SINR for the second beam, and one of an SINR threshold value and an SINR difference threshold value.

In some embodiments of the method 300, the threshold value is pre-defined at the UE.

In some embodiments of the method 300, the threshold value is one of a range of values pre-defined at the UE and that is indicated to the UE in a group-based beam reporting configuration.

In some embodiments of the method 300, the threshold value is one of a range of values pre-defined at the UE and that is indicated to the network in a UE capability message.

In some embodiments of the method 300, the beam reporting message indicates a plurality of qualified beam pairs including the qualified beam pair and further indicates a ranking of the plurality of qualified beam pairs. In some such embodiments, a rank of the qualified beam pair within the plurality of qualified beam pairs is based on a sum of the first RSRP for the first beam and the second RSRP of the second beam. In some such embodiments, a rank of the qualified beam pair within the plurality of qualified beam pairs is based on a minimum of the first RSRP for the first beam and the second RSRP for the second beam. In some such embodiments, a rank of the qualified beam pair within the plurality of qualified beam pairs is based on a maximum of the first RSRP for the first beam and the second RSRP for the second beam. In some such embodiments, a rank of the qualified beam pair within the plurality of qualified beam pairs is based on a sum of a first SINR for the first beam and a second SINR of the second beam. In some such embodiments, a rank of the qualified beam pair within the plurality of qualified beam pairs is based on a sum of a first effective channel capability that is calculated using a first SINR for the first beam and a second effective channel capability that is calculated using a second SINR of the second beam. In some such embodiments, a rank of the qualified beam pair within the plurality of qualified beam pairs is based on a minimum of a first SINR for the first beam and a second SINR of the second beam. In some such embodiments, a rank of the qualified beam pair within the plurality of qualified beam pairs is based on a maximum of a first SINR for the first beam and a second SINR of the second beam.

In some embodiments of the method 300, the beam reporting message further includes a first SINR for the first beam and a second SINR for the second beam.

In some embodiments of the method 300, the first beam is from a first CMR set configured to the UE, and wherein the second beam is from a second CMR set configured to the UE. In some such embodiments, the method 300 further includes determining that the first beam and the second beam are associated with each other in a list of beam pairs received at the UE from the network that is a subset of all possible beam pairs taken across the first CMR set and the second CMR set.

In some embodiments of the method 300, the first beam and the second beam are identified to the UE by the network.

In some embodiments, the method 300 further includes receiving, from the network, an instruction to use a same reference signal type to determine the qualified beam pair, and wherein the first reference signal and the second reference signal are of the same reference signal type.

In some embodiments, the method 300 further includes sending, to the network, a beam pair update message indicating one or more replacement beams for one or more of the first beam and the second beam and replacing the one or more of the first beam and the second beam within the qualified beam pair with the one or more replacement beams. In some such embodiments, the beam pair update message is sent in one of UCI and a MAC-CE.

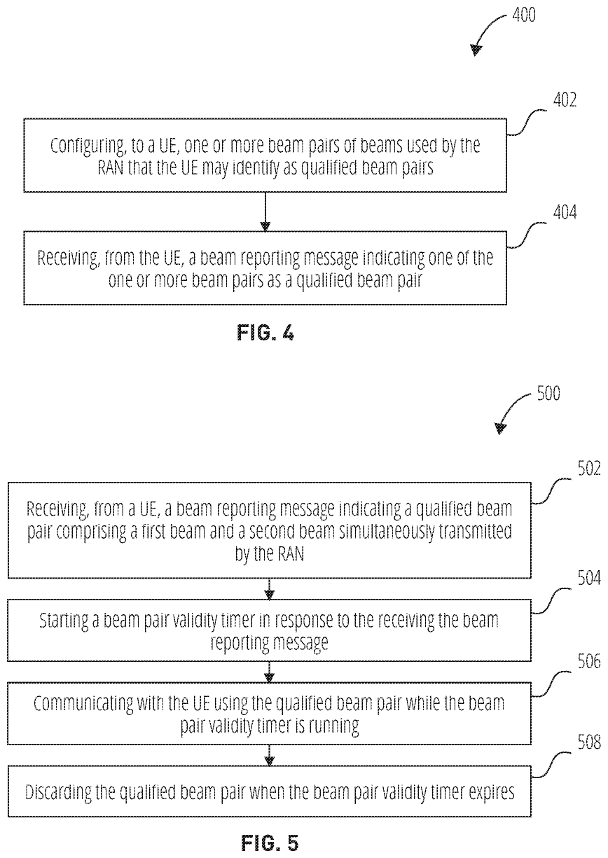

FIG. 4 illustrates a method 400 of a RAN, according to embodiments herein. The method 400 includes configuring 402, to a UE, one or more beam pairs of beams used by the RAN that the UE may identify as qualified beam pairs.

The method 400 further includes receiving 404, from the UE, a beam reporting message indicating one of the one or more beam pairs as a qualified beam pair.

In some embodiments of the method 400, the one or more beam pairs are derived by the RAN from a set of all possible beam pairs taken across a first CMR set and a second CMR set configured at the UE by the RAN.

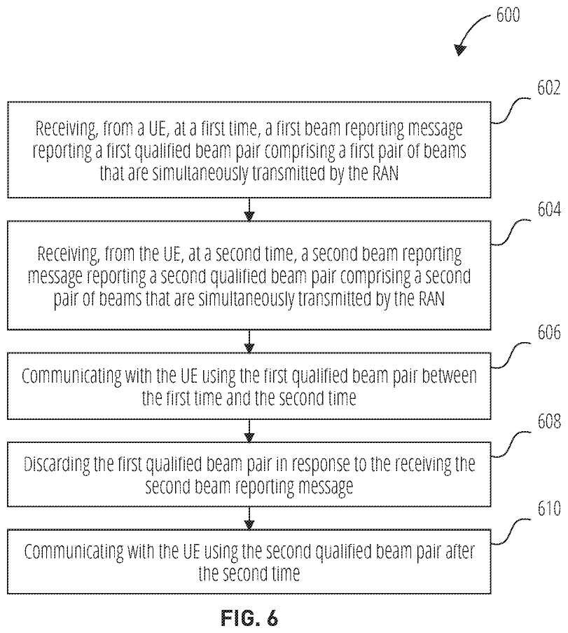

FIG. 5 illustrates a method 500 of a RAN, according to embodiments herein. The method 500 includes receiving 502, from a UE, a beam reporting message indicating a qualified beam pair comprising a first beam and a second beam simultaneously transmitted by the RAN.

The method 500 further includes starting 504 a beam pair validity timer in response to the receiving the beam reporting message.

The method 500 further includes communicating 506 with the UE using the qualified beam pair while the beam pair validity timer is running.

The method 500 further includes discarding 508 the qualified beam pair when the beam pair validity timer expires.

In some embodiments of the method 500, the beam pair validity timer is started using a starting value provided by the UE in the beam reporting message.

In some embodiments, the method 500 further includes configuring a first active TCI state for the first beam and a second TCI state for the second beam and resetting the beam pair validity timer upon receiving HARQ-ACKs corresponding to each of the first active TCI state and the second active TCI state.

In some embodiments, the method 500 further includes resetting the beam pair validity timer to an override value provided in an override indication received from the UE. In some such embodiments, the override indication is received from the UE in one of an RRC message, a MAC-CE, and UCI.

In some embodiments, the method 500 further includes receiving, from the UE, a beam pair update message indicating one or more replacement beams for one or more of the first beam and the second beam and replacing the one or more of the first beam and the second beam in the qualified beam pair with the one or more replacement beams. In some such embodiments, the beam pair update message is received in one of UCI and a MAC-CE.

FIG. 6 illustrates a method 600 of a RAN, according to embodiments herein. The method 600 includes receiving 602, from a UE, at a first time, a first beam reporting message reporting a first qualified beam pair comprising a first pair of beams that are simultaneously transmitted by the RAN.

The method 600 further includes receiving 604, from the UE, at a second time, a second beam reporting message reporting a second qualified beam pair comprising a second pair of beams that are simultaneously transmitted by the RAN.

The method 600 further includes communicating 606 with the UE using the first qualified beam pair between the first time and the second time.

The method 600 further includes discarding 608 the first qualified beam pair in response to the receiving the second beam reporting message.

The method 600 further includes communicating 610 with the UE using the second qualified beam pair after the second time.

In some embodiments, the method 600 further includes starting a beam pair validity timer in response to the receiving the first beam reporting message and resetting the beam pair validity timer in response to receiving the second beam reporting message.

In some embodiments, the method 600 further includes receiving, from the UE, a beam pair update message indicating one or more replacement beams for one or more of a first beam and a second beam of the first pair of beams and replacing the one or more of the first beam and the second beam within the first qualified beam pair with the one or more replacement beams.

In some embodiments of the method 600, the beam pair update message is received in one of UCI and a MAC-CE.

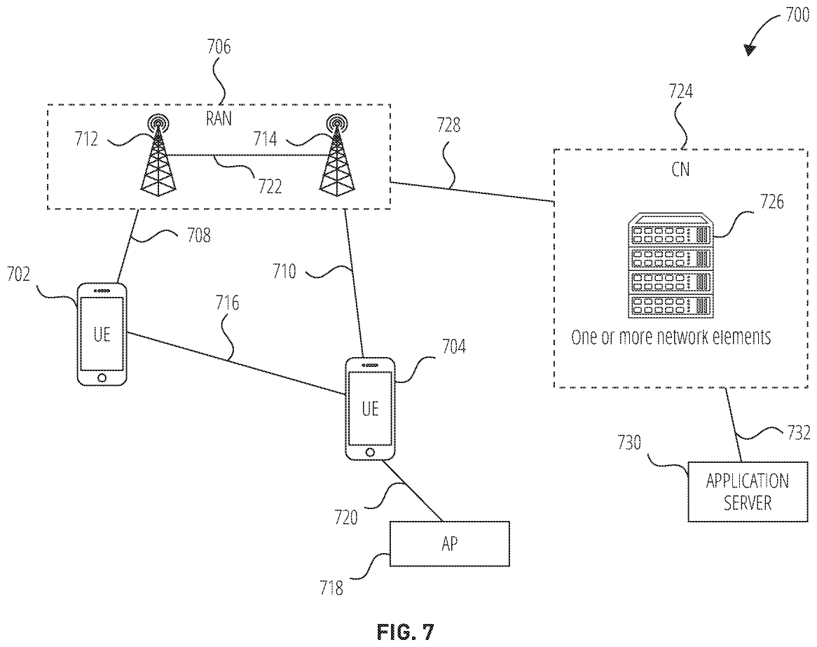

FIG. 7 illustrates an example architecture of a wireless communication system 700, according to embodiments disclosed herein. The following description is provided for an example wireless communication system 700 that operates in conjunction with the LTE system standards and/or 5G or NR system standards as provided by 3GPP technical specifications.

As shown by FIG. 7, the wireless communication system 700 includes UE 702 and UE 704 (although any number of UEs may be used). In this example, the UE 702 and the UE 704 are illustrated as smartphones (e.g., handheld touchscreen mobile computing devices connectable to one or more cellular networks), but may also comprise any mobile or non mobile computing device configured for wireless communication.

The UE 702 and UE 704 may be configured to communicatively couple with a RAN 706. In embodiments, the RAN 706 may be NG-RAN, E-UTRAN, etc. The UE 702 and UE 704 utilize connections (or channels) (shown as connection 708 and connection 710, respectively) with the RAN 706, each of which comprises a physical communications interface. The RAN 706 can include one or more base stations (such as base station 712 and base station 714) that enable the connection 708 and connection 710.

In this example, the connection 708 and connection 710 are air interfaces to enable such communicative coupling, and may be consistent with RAT(s) used by the RAN 706, such as, for example, an LTE and/or NR.

In some embodiments, the UE 702 and UE 704 may also directly exchange communication data via a sidelink interface 716. The UE 704 is shown to be configured to access an access point (shown as AP 718) via connection 720. By way of example, the connection 720 can comprise a local wireless connection, such as a connection consistent with any IEEE 802.11 protocol, wherein the AP 718 may comprise a Wi-Fi router. In this example, the AP 718 may be connected to another network (for example, the Internet) without going through a CN 724.

In embodiments, the UE 702 and UE 704 can be configured to communicate using orthogonal frequency division multiplexing (OFDM) communication signals with each other or with the base station 712 and/or the base station 714 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 712 or base station 714 may be implemented as one or more software entities running on server computers as part of a virtual network. In addition, or in other embodiments, the base station 712 or base station 714 may be configured to communicate with one another via interface 722. In embodiments where the wireless communication system 700 is an LTE system (e.g., when the CN 724 is an EPC), the interface 722 may be an X2 interface. The X2 interface may be defined between two or more base stations (e.g., two or more eNBs and the like) that connect to an EPC, and/or between two eNBs connecting to the EPC. In embodiments where the wireless communication system 700 is an NR system (e.g., when CN 724 is a 5GC), the interface 722 may be an Xn interface. The Xn interface is defined between two or more base stations (e.g., two or more gNBs and the like) that connect to 5GC, between a base station 712 (e.g., a gNB) connecting to 5GC and an eNB, and/or between two eNBs connecting to 5GC (e.g., CN 724).

The RAN 706 is shown to be communicatively coupled to the CN 724. The CN 724 may comprise one or more network elements 726, which are configured to offer various data and telecommunications services to customers/subscribers (e.g., users of UE 702 and UE 704) who are connected to the CN 724 via the RAN 706. The components of the CN 724 may be implemented in one physical device or separate physical devices including components to read and execute instructions from a machine-readable or computer-readable medium (e.g., a non-transitory machine-readable storage medium).

In embodiments, the CN 724 may be an EPC, and the RAN 706 may be connected with the CN 724 via an S1 interface 728. In embodiments, the SI interface 728 may be split into two parts, an S1 user plane (S1-U) interface, which carries traffic data between the base station 712 or base station 714 and a serving gateway (S-GW), and the S1-MME interface, which is a signaling interface between the base station 712 or base station 714 and mobility management entities (MMEs).

In embodiments, the CN 724 may be a 5GC, and the RAN 706 may be connected with the CN 724 via an NG interface 728. In embodiments, the NG interface 728 may be split into two parts, an NG user plane (NG-U) interface, which carries traffic data between the base station 712 or base station 714 and a user plane function (UPF), and the S1 control plane (NG-C) interface, which is a signaling interface between the base station 712 or base station 714 and access and mobility management functions (AMFs).

Generally, an application server 730 may be an element offering applications that use internet protocol (IP) bearer resources with the CN 724 (e.g., packet switched data services). The application server 730 can also be configured to support one or more communication services (e.g., VoIP sessions, group communication sessions, etc.) for the UE 702 and UE 704 via the CN 724. The application server 730 may communicate with the CN 724 through an IP communications interface 732.

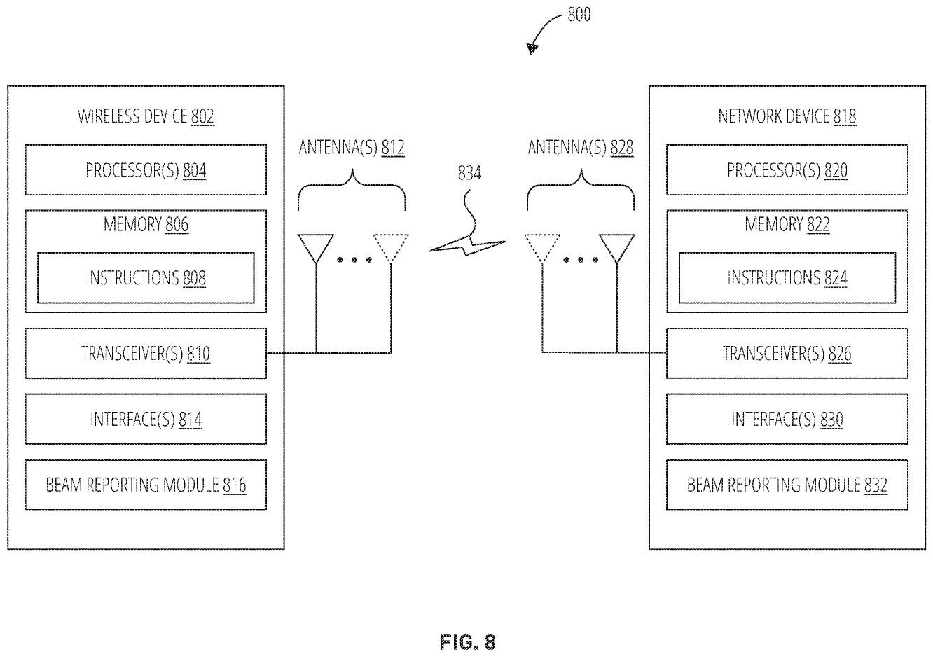

FIG. 8 illustrates a system 800 for performing signaling 834 between a wireless device 802 and a network device 818, according to embodiments disclosed herein. The system 800 may be a portion of a wireless communications system as herein described. The wireless device 802 may be, for example, a UE of a wireless communication system. The network device 818 may be, for example, a base station (e.g., an eNB or a gNB) of a wireless communication system.

The wireless device 802 may include one or more processor(s) 804. The processor(s) 804 may execute instructions such that various operations of the wireless device 802 are performed, as described herein. The processor(s) 804 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 802 may include a memory 806. The memory 806 may be a non-transitory computer-readable storage medium that stores instructions 808 (which may include, for example, the instructions being executed by the processor(s) 804). The instructions 808 may also be referred to as program code or a computer program. The memory 806 may also store data used by, and results computed by, the processor(s) 804.

The wireless device 802 may include one or more transceiver(s) 810 that may include radio frequency (RF) transmitter and/or receiver circuitry that use the antenna(s) 812 of the wireless device 802 to facilitate signaling (e.g., the signaling 834) to and/or from the wireless device 802 with other devices (e.g., the network device 818) according to corresponding RATs.

The wireless device 802 may include one or more antenna(s) 812 (e.g., one, two, four, or more). For embodiments with multiple antenna(s) 812, the wireless device 802 may leverage the spatial diversity of such multiple antenna(s) 812 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 802 may be accomplished according to precoding (or digital beamforming) that is applied at the wireless device 802 that multiplexes the data streams across the antenna(s) 812 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 802 may implement analog beamforming techniques, whereby phases of the signals sent by the antenna(s) 812 are relatively adjusted such that the (joint) transmission of the antenna(s) 812 can be directed (this is sometimes referred to as beam steering).

The wireless device 802 may include one or more interface(s) 814. The interface(s) 814 may be used to provide input to or output from the wireless device 802. For example, a wireless device 802 that is a UE may include interface(s) 814 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 810/antenna(s) 812 already described) that allow for communication between the UE and other devices and may operate according to known protocols (e.g., Wi-Fi®, Bluetooth®, and the like).

The wireless device 802 may include a beam reporting module 816. The beam reporting module 816 may be implemented via hardware, software, or combinations thereof. For example, the beam reporting module 816 may be implemented as a processor, circuit, and/or instructions 808 stored in the memory 806 and executed by the processor(s) 804. In some examples, the beam reporting module 816 may be integrated within the processor(s) 804 and/or the transceiver(s) 810. For example, the beam reporting module 816 may be implemented by a combination of software components (e.g., executed by a DSP or a general processor) and hardware components (e.g., logic gates and circuitry) within the processor(s) 804 or the transceiver(s) 810.

The beam reporting module 816 may be used for various aspects of the present disclosure, for example, aspects of FIG. 1 through FIG. 6. The beam reporting module 816 may be configured to, for example, identify qualified beam pairs and/or generate and send one or more beam reporting messages regarding one or more qualified beam pairs to a network, in the manner described herein.

The network device 818 may include one or more processor(s) 820. The processor(s) 820 may execute instructions such that various operations of the network device 818 are performed, as described herein. The processor(s) 820 may include one or more baseband processors implemented using, for example, a CPU, a DSP, an ASIC, a controller, an FPGA device, another hardware device, a firmware device, or any combination thereof configured to perform the operations described herein.

The network device 818 may include a memory 822. The memory 822 may be a non-transitory computer-readable storage medium that stores instructions 824 (which may include, for example, the instructions being executed by the processor(s) 820). The instructions 824 may also be referred to as program code or a computer program. The memory 822 may also store data used by, and results computed by, the processor(s) 820.

The network device 818 may include one or more transceiver(s) 826 that may include RF transmitter and/or receiver circuitry that use the antenna(s) 828 of the network device 818 to facilitate signaling (e.g., the signaling 834) to and/or from the network device 818 with other devices (e.g., the wireless device 802) according to corresponding RATs.

The network device 818 may include one or more antenna(s) 828 (e.g., one, two, four, or more). In embodiments having multiple antenna(s) 828, the network device 818 may perform MIMO, digital beamforming, analog beamforming, beam steering, etc., as has been described.

The network device 818 may include one or more interface(s) 830. The interface(s) 830 may be used to provide input to or output from the network device 818. For example, a network device 818 that is a base station may include interface(s) 830 made up of transmitters, receivers, and other circuitry (e.g., other than the transceiver(s) 826/antenna(s) 828 already described) that enables the base station to communicate with other equipment in a core network, and/or that enables the base station to communicate with external networks, computers, databases, and the like for purposes of operations, administration, and maintenance of the base station or other equipment operably connected thereto.

The network device 818 may include a beam reporting module 832. The beam reporting module 832 may be implemented via hardware, software, or combinations thereof. For example, the beam reporting module 832 may be implemented as a processor, circuit, and/or instructions 824 stored in the memory 822 and executed by the processor(s) 820. In some examples, the beam reporting module 832 may be integrated within the processor(s) 820 and/or the transceiver(s) 826. For example, the beam reporting module 832 may be implemented by a combination of software components (e.g., executed by a DSP or a general processor) and hardware components (e.g., logic gates and circuitry) within the processor(s) 820 or the transceiver(s) 826.

The beam reporting module 832 may be used for various aspects of the present disclosure, for example, aspects of FIG. 1 through FIG. 6. The beam reporting module 832 may be configured to, for example, receive and/or process one or more beam reporting messages regarding one or more qualified beam pairs received from a UE and communicate with the UE using the one or more qualified beam pairs, in the manner described herein.

Embodiments contemplated herein include an apparatus comprising means to perform one or more elements of the method 300. This apparatus may be, for example, an apparatus of a UE (such as a wireless device 802 that is a UE, as described herein).

Embodiments contemplated herein include one or more non-transitory computer-readable media comprising instructions to cause an electronic device, upon execution of the instructions by one or more processors of the electronic device, to perform one or more elements of the method 300. This non-transitory computer-readable media may be, for example, a memory of a UE (such as a memory 806 of a wireless device 802 that is a UE, as described herein).

Embodiments contemplated herein include an apparatus comprising logic, modules, or circuitry to perform one or more elements of the method 300. This apparatus may be, for example, an apparatus of a UE (such as a wireless device 802 that is a UE, as described herein).

Embodiments contemplated herein include an apparatus comprising: one or more processors and one or more computer-readable media comprising instructions that, when executed by the one or more processors, cause the one or more processors to perform one or more elements of the method 300. This apparatus may be, for example, an apparatus of a UE (such as a wireless device 802 that is a UE, as described herein).

Embodiments contemplated herein include a signal as described in or related to one or more elements of the method 300.

Embodiments contemplated herein include a computer program or computer program product comprising instructions, wherein execution of the program by a processor is to cause the processor to carry out one or more elements of the method 300. The processor may be a processor of a UE (such as a processor(s) 804 of a wireless device 802 that is a UE, as described herein). These instructions may be, for example, located in the processor and/or on a memory of the UE (such as a memory 806 of a wireless device 802 that is a UE, as described herein).

Embodiments contemplated herein include an apparatus comprising means to perform one or more elements of any of the method 400, the method 500, and the method 600. This apparatus may be, for example, an apparatus of a base station (such as a network device 818 that is a base station, as described herein).

Embodiments contemplated herein include one or more non-transitory computer-readable media comprising instructions to cause an electronic device, upon execution of the instructions by one or more processors of the electronic device, to perform one or more elements of any of the method 400, the method 500, and the method 600. This non-transitory computer-readable media may be, for example, a memory of a base station (such as a memory 822 of a network device 818 that is a base station, as described herein).

Embodiments contemplated herein include an apparatus comprising logic, modules, or circuitry to perform one or more elements of any of the method 400, the method 500, and the method 600. This apparatus may be, for example, an apparatus of a base station (such as a network device 818 that is a base station, as described herein).

Embodiments contemplated herein include an apparatus comprising: one or more processors and one or more computer-readable media comprising instructions that, when executed by the one or more processors, cause the one or more processors to perform one or more elements of any of the method 400, the method 500, and the method 600. This apparatus may be, for example, an apparatus of a base station (such as a network device 818 that is a base station, as described herein).

Embodiments contemplated herein include a signal as described in or related to one or more elements of any of the method 400, the method 500, and the method 600.

Embodiments contemplated herein include a computer program or computer program product comprising instructions, wherein execution of the program by a processing element is to cause the processing element to carry out one or more elements of any of the method 400, the method 500, and the method 600. The processor may be a processor of a base station (such as a processor(s) 820 of a network device 818 that is a base station, as described herein). These instructions may be, for example, located in the processor and/or on a memory of the base station (such as a memory 822 of a network device 818 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing, both the processes and apparatuses described herein. Accordingly, the present embodiments are to be considered illustrative and not restrictive, and the description is not to be limited to the details given herein, but may be modified within the scope and equivalents of the appended claims.

1. A method of a user equipment (UE), comprising:
determining a first characteristic of a first beam used by a network that is received on a first antenna panel of the UE using a first reference signal transmitted on the first beam;
determining a second characteristic of a second beam used by the network that is received on a second antenna panel of the UE using a second reference signal transmitted on the second beam, wherein the first beam and the second beam are received at the UE simultaneously;
determining that a qualified beam pair comprises the first beam and the second beam using the first characteristic, the second characteristic, and a threshold value; and
sending, to the network, a beam reporting message indicating the qualified beam pair comprising the first beam and the second beam, wherein the beam reporting message comprises a first reference signal received power (RSRP) for the first beam and a second RSRP for the second beam.

2. The method of claim 1, wherein:
the first characteristic of the first beam comprises the first RSRP for the first beam,
the second characteristic comprises the second RSRP for the second beam,
the threshold value comprises an RSRP threshold value, and
the determining that the qualified beam pair comprises the first beam and the second beam comprises:
comparing the first RSRP to the RSRP threshold value; and
comparing the second RSRP to the RSRP threshold value.

3. The method of claim 1, wherein:
the first characteristic of the first beam comprises the first RSRP for the first beam,
the second characteristic comprises the second RSRP for the second beam,
the threshold value comprises an RSRP difference threshold value, and
the determining that the qualified beam pair comprises the first beam and the second beam comprises:
calculating a difference between the first RSRP and the second RSRP; and
comparing the difference between the first RSRP and the second RSRP to the RSRP difference threshold value.

4. The method of claim 1, wherein:
the first characteristic of the first beam comprises a first angle of arrival (AoA) for the first beam,
the second characteristic comprises a second AoA for the second beam,
the threshold value comprises an AoA offset threshold value, and
the determining that the qualified beam pair comprises the first beam and the second beam comprises:
calculating an offset between the first AoA and the second AoA; and
comparing the offset between the first AoA and the second AoA to the AoA offset threshold value.

5. The method of claim 1, wherein:
the first characteristic of the first beam comprises a first signal to noise and interference ratio (SINR) for the first beam,
the second characteristic comprises a second SINR for the second beam,
the threshold value comprises an SINR threshold value, and
the determining that the qualified beam pair comprises the first beam and the second beam comprises:
comparing the first SINR to the SINR threshold value; and
comparing the second SINR to the SINR threshold value.

6. The method of claim 1, wherein:
the first characteristic of the first beam comprises a first signal to noise and interference ratio (SINR) for the first beam,
the second characteristic comprises a second SINR for the second beam,
the threshold value comprises an SINR difference threshold value, and
the determining the qualified beam pair comprises the first beam and the second beam comprises:
calculating a difference between the first SINR and the second SINR; and
comparing the difference between the first SINR and the second SINR to the SINR difference threshold value.

7. The method of claim 1, the method of claim 1, wherein:
the first characteristic of the first beam comprises the first RSRP for the first beam,
the second characteristic comprises the second RSRP for the second beam,
the threshold value comprises one of an RSRP threshold value and an RSRP difference threshold value, and
the determining that a qualified beam pair comprises the first beam and the second beam further comprises using a first signal to noise and interference ratio (SINR) for the first beam, a second SINR for the second beam, and one of an SINR threshold value and an SINR difference threshold value.

8. The method of claim 1, wherein the threshold value is pre-defined at the UE.

9. The method of claim 1, wherein the threshold value is one of a range of values pre-defined at the UE and that is indicated to the UE in a group-based beam reporting configuration.

10. The method of claim 1, wherein the threshold value is one of a range of values pre-defined at the UE and that is indicated to the network in a UE capability message.

11. The method of claim 1, wherein the beam reporting message indicates a plurality of qualified beam pairs including the qualified beam pair and further indicates a ranking of the plurality of qualified beam pairs.

12. The method of claim 11, wherein a rank of the qualified beam pair within the plurality of qualified beam pairs is based on a sum of the first RSRP for the first beam and the second RSRP of the second beam.

13. The method of claim 11, wherein a rank of the qualified beam pair within the plurality of qualified beam pairs is based on a minimum of the first RSRP for the first beam and the second RSRP for the second beam.

14. The method of claim 11, wherein a rank of the qualified beam pair within the plurality of qualified beam pairs is based on a maximum of the first RSRP for the first beam and the second RSRP for the second beam.

15. The method of claim 11, wherein a rank of the qualified beam pair within the plurality of qualified beam pairs is based on a sum of a first signal to noise and interference ratio (SINR) for the first beam and a second SINR of the second beam.

16. The method of claim 11, wherein a rank of the qualified beam pair within the plurality of qualified beam pairs is based on a sum of a first effective channel capability that is calculated using a first signal to noise and interference ratio (SINR) for the first beam and a second effective channel capability that is calculated using a second SINR of the second beam.

17. The method of claim 11, wherein a rank of the qualified beam pair within the plurality of qualified beam pairs is based on a minimum of a first signal to noise and interference ratio (SINR) for the first beam and a second SINR of the second beam.

18. The method of claim 11, wherein a rank of the qualified beam pair within the plurality of qualified beam pairs is based on a maximum of a first signal to noise and interference ratio (SINR) for the first beam and a second SINR of the second beam.

19. The method of claim 1, wherein the beam reporting message further includes a first signal to noise and interference ratio (SINR) for the first beam and a second SINR for the second beam.

20. The method of claim 1, wherein the first beam is from a first channel measurement resource (CMR) set configured to the UE, and wherein the second beam is from a second CMR set configured to the UE.

21-38. (canceled)
